(19) United States
(12) Patent Application Publication
(10) Pub. No.: US 2025/0028726 A1
(43) Pub. Date: Jan. 23, 2025

(54) DATA MATCHING DEVICE, DATA MATCHING METHOD, AND DATA MATCHING PROGRAM

(71) Applicant: HONDA MOTOR CO., LTD., Tokyo (JP)

(72) Inventor: Kentaro SUGIMURA, Saitama (JP)

(73) Assignee: HONDA MOTOR CO., LTD., Tokyo (JP)

(21) Appl. No.: 18/713,714

(22) PCT Filed: Nov. 29, 2021
(86) PCT No.: PCT/JP2021/043627

§ 371 Date: May 28, 2024

(51) Int. Cl. G06F 16/248

(52) U.S. Cl. CPC G06F 16/248

(57) ABSTRACT

A data matching device capable of obtaining first data that is transmitted from a moving object configured to perform wireless communication and that is related to the moving object, and second data that is transmitted from a charging device configured to charge a battery used in the moving object and that is related to the battery. The data matching device is configured to: generate matched data in which the obtained first data and the obtained second data are associated with each other, when obtaining the first data and the second data; and output the generated matched data to a predetermined output destination.

### TECHNICAL FIELD

The present invention relates to a data matching device, a data matching method, and a data matching program.

### BACKGROUND ART

In recent years, with the spread of Internet of Things (IoT), attempts have been made to collect data from a moving object such as a vehicle. For communication with such a moving object, wireless communication using a mobile communication network such as a cellular line is often adopted.

Patent Literature 1 describes a technique in which, when there is no traffic for a predetermined time or more since a last traffic, user equipment (UE), which is a wireless terminal, enters an intermittent reception state, and repeatedly pauses a part of a device related to reception and returns from a pause state.

### CITATION LIST

### Patent Literature

Patent Literature 1: International Patent Application Publication No. 2014/103804

### SUMMARY OF INVENTION

### Technical Problem

In general, wireless communication using a mobile communication network such as a cellular line has a higher communication cost and is often inferior in terms of communication speed and stability than communication using a fixed line such as an optical line. Under such circumstances, it has been desired to reduce a communication amount of a moving object that performs wireless communication as much as possible. On the other hand, when the communication amount of the moving object is reduced, the convenience of a user may be decreased, for example, data required by the user may not be appropriately obtained.

The present invention provides a data matching device, a data matching method, and a data matching program capable of preventing a decrease in convenience of a user even when a communication amount of a moving object that performs wireless communication is reduced.

### Solution to Problem

A first invention is a data matching device capable of obtaining first data that is transmitted from a moving object configured to perform wireless communication and that is related to the moving object, and second data that is transmitted from a charging device configured to charge a battery used in the moving object and that is related to the battery, in which the data matching device is configured to:
generate matched data in which the obtained first data and the obtained second data are associated with each other, when obtaining the first data and the second data, and
output the generated matched data to a predetermined output destination.

A second invention is a data matching method performed by a computer capable of obtaining first data that is transmitted from a moving object configured to perform wireless communication and that is related to the moving object, and second data that is transmitted from a charging device configured to charge a battery used in the moving object and that is related to the battery, the data matching method including:
generating matched data in which the obtained first data and the obtained second data are associated with each other, when obtaining the first data and the second data; and
outputting the generated matched data to a predetermined output destination.

A third invention is a data matching program causing a computer to execute a process, the computer being capable of obtaining first data that is transmitted from a moving object configured to perform wireless communication and that is related to the moving object, and second data that is transmitted from a charging device configured to charge a battery used in the moving object and that is related to the battery, the process including:
generating matched data in which the obtained first data and the obtained second data are associated with each other, when obtaining the first data and the second data; and
outputting the generated matched data to a predetermined output destination.

### Advantageous Effects of Invention

According to the present invention, it is possible to provide a data matching device, a data matching method, and a data matching program capable of preventing a decrease in convenience of a user even when a communication amount of a moving object that performs wireless communication is reduced.

### BRIEF DESCRIPTION OF DRAWINGS

FIG. 1 is a diagram showing an example of a data matching system 1 to which a data matching device 10 according to an embodiment of the present invention is applied.

FIG. 2 is a diagram showing an example of a working machine 20.

FIG. 3 is a diagram showing an example of working machine data D1 transmitted from the working machine 20 to the data matching device 10.

FIG. 4 is a diagram showing an example of a charging device 30 that charges a battery BAT used in the working machine 20.

FIG. 5 is a diagram showing an example of battery data D2 transmitted from the charging device 30 to the data matching device 10.

FIG. 6 is a diagram showing an example of the data matching device 10.

FIG. 7 is a diagram showing an example of a working machine data table Tb1 stored in the data matching device 10.

FIG. 8 is a diagram showing an example of a battery management table Tb2 stored in the data matching device 10.

FIG. 9 is a flowchart showing an example of a data matching process (data matching method) executed by the data matching device 10.

### DESCRIPTION OF EMBODIMENTS

Hereinafter, an embodiment of a data matching device, a data matching method, and a data matching program of the present invention will be described in detail with reference to the drawings. In the following embodiment, an example will be described in which a moving object in the present invention is a working machine used for a predetermined work, such as a lawn mower or a blower.

First, background circumstances and the like in the present embodiment will be described. In recent years, as a specific countermeasure against global climate change, efforts toward realization of a low-carbon society or a decarbonized society are activated. As one of the efforts, in a device equipped with a drive source such as a vehicle, electrification of the drive source is progressing, and such a growing trend toward electrification is also extending to the field of working machines.

In addition, in recent years, information technology (IT) of a working machine is also progressing for a purpose of improving working efficiency and the like. For example, it is conceivable to guide an operating status of a working machine to an operator who operates the working machine so that the operator can grasp a working machine that is not operating or a working machine with low working efficiency. For example, when the working machine is a lawn mower, the operator may be a landscape gardener who undertakes mowing of lawns or the like in a predetermined public space (for example, a park). If the working machine that is not operating or the working machine with low working efficiency can be grasped, for example, the operator can effectively use the working machine that is not operating by transferring the working machine to another site, or can improve the working efficiency by replacing the working machine with low working efficiency with another working machine.

In order to realize the IT of the working machine, it is necessary to appropriately collect data from the working machine. In general, since the working machine is a moving object, wireless communication using a mobile communication network such as a cellular line (hereinafter, also simply referred to as “wireless communication”) is used for communication by the working machine. However, such wireless communication has a higher communication cost than, for example, communication using a fixed line such as an optical line, and the communication cost may be a heavy burden on the operator who operates the working machine (a communication fee may be paid by a working machine manufacturer, and in this case, the operator may be referred to the working machine manufacturer). Under such circumstances, it is desirable to reduce a communication amount of the working machine that performs wireless communication as much as possible.

Therefore, the data matching device, the data matching method, and the data matching program according to the present embodiment make it possible to reduce the communication amount of the working machine that performs wireless communication while preventing a decrease in convenience of a user such as an operator.

### [Data Matching System]

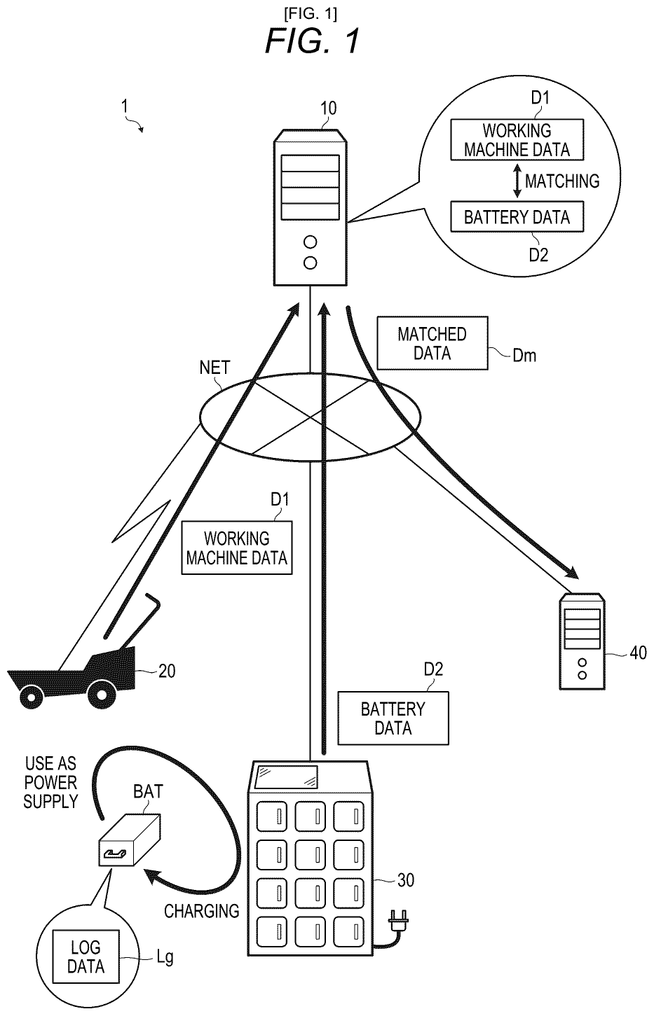

First, a data matching system to which the data matching device of the present embodiment is applied will be described. As shown in FIG. 1, a data matching system 1 is configured such that a data matching device 10 of the present embodiment can communicate with each of a working machine 20, a charging device 30, and a computer 40 via a network NET. The network NET is, for example, the Internet.

The data matching device 10 is, for example, a server device (computer) managed by a service provider that provides various data to an operator who operates the working machine 20 (hereinafter, also simply referred to as the “operator”). The computer 40 is an example of a predetermined output destination in the present invention, and is a computer of the operator. The computer 40 may be a server device managed by the operator, or may be a terminal device (for example, a smartphone, a tablet terminal, or a PC) used by an employee of the operator.

The computer 40 which is an output destination of data of the data matching device 10 is set in advance in the data matching device 10 by, for example, the service provider. The data matching device 10 may be provided as a part of the computer 40, and in this case, the output destination of the data of the data matching device 10 may be a display or the like included in the computer 40.

The data matching device 10 may be the server device managed by the operator, and the computer 40 may be the terminal device used by the employee of the operator. Further, the data matching device 10 may be the above server device managed by the service provider, and the computer 40 may be a server device managed by a rental provider who lends the working machine 20 to the operator.

The working machine 20 is an example of the moving object in the present invention. The working machine 20 is an electric working machine (for example, a lawn mower) which has a detachable battery BAT including a secondary battery such as a lithium ion battery, and is driven by the attached battery BAT as a power supply. The battery BAT is removed from the working machine 20 after being used in the working machine 20, and is then attached to the charging device 30. The charging device 30 is connected to an external power supply (for example, a commercial power supply), and charges the attached battery BAT with electric power of the external power supply. The battery BAT charged by the charging device 30 can be reused as the power supply of the working machine 20. The battery BAT may be owned by the operator or may be rented to the operator by the service provider.

Here, the battery BAT is configured to store log data Lg regarding a use state of an own machine and output the stored log data Lg to the outside of the battery BAT (for example, the charging device 30). Specifically, the battery BAT includes a battery integrated circuit (IC), which is a microcontroller that integrally controls the entire battery BAT, a nonvolatile storage medium such as a flash memory, and a battery sensor (all not shown).

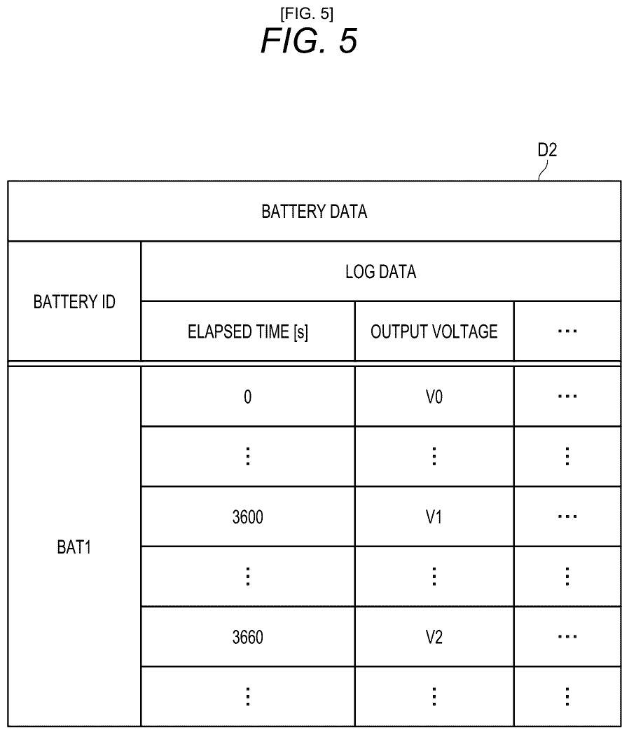

The battery sensor detects an output voltage, a charge and discharge current, a temperature, and the like of the battery BAT. Based on a detection result of the battery sensor, the battery IC generates the log data Lg indicating a time-series change (for example, a substantially continuous change at intervals of one second, see FIG. 5) of the output voltage or the like of the battery BAT in a predetermined target period. Here, the target period is a period from when the battery BAT is removed from the charging device 30 to when the battery BAT is attached to the charging device 30 again. That is, a period in which the battery BAT is used in the working machine 20 is included in the target period, and the log data Lg is generated.

The log data Lg may include information other than the output voltage of the battery BAT. For example, the log data Lg may include information indicating a time-series change in the temperature of the battery BAT in the target period. Further, the battery BAT may be provided with an acceleration sensor, so that the log data Lg may include, for example, information indicating the number of times an acceleration (that is, an impact) equal to or greater than a predetermined value occurs in the battery BAT.

The log data Lg generated by the battery IC is stored in the storage medium of the battery BAT. When the battery BAT is attached to the charging device 30, the battery IC transmits battery data including the log data Lg stored in the storage medium to the charging device 30. Here, the battery data is data in which a battery ID for identifying the battery BAT is associated with the log data Lg. Communication between the battery BAT and the charging device 30 may be performed via a physical terminal or the like, or may be performed by short-range wireless communication.

### [Working Machine]

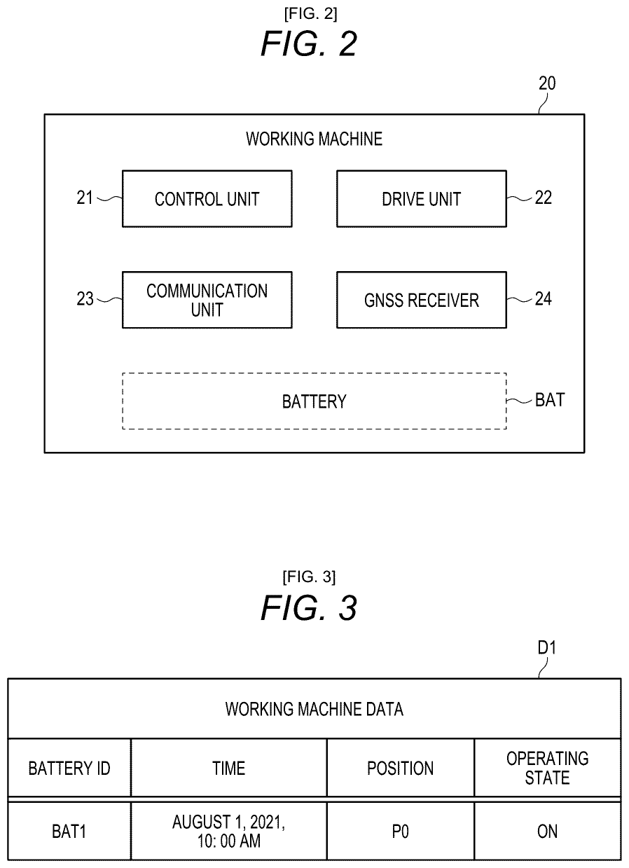

Next, the working machine 20 will be specifically described. As shown in FIG. 2, the working machine 20 includes a control unit 21, a drive unit 22, a communication unit 23, and a GNSS receiver 24. As described above, the battery BAT can be attached to the working machine 20, and the battery BAT attached to the working machine 20 is indicated by a broken line in FIG. 2.

The control unit 21 integrally controls the entire working machine 20. The control unit 21 is implemented by, for example, an electronic control unit (ECU) including a processor, a memory, an input and output interface, and the like. The drive unit 22 outputs power for causing the working machine 20 to travel or operating a working unit (not shown) of the working machine 20 (for example, a blade unit for mowing lawns in a case of a lawn mower) under the control of the control unit 21. The drive unit 22 is implemented by, for example, a motor that is driven using electric power of the battery BAT attached to the working machine 20.

The communication unit 23 communicates with the outside of the working machine 20 (for example, the data matching device 10) by wireless communication under the control of the control unit 21. The communication unit 23 is implemented by, for example, a telematics control unit (TCU) that can access the network NET by wireless communication. The GNSS receiver 24 identifies a point where the GNSS receiver 24 is located at a certain time (that is, a position of the working machine 20) based on a signal received from a GNSS satellite, and outputs information indicating the specification result to the control unit 21.

The control unit 21 generates working machine data D1 related to the working machine 20 based on the information obtained from the GNSS receiver 24 or the like, and transmits the generated working machine data D1 to the data matching device 10 through wireless communication by the communication unit 23 at a predetermined cycle (see also FIG. 1). The cycle at which the working machine 20 (control unit 21) transmits the working machine data D1 to the data matching device 10 is set in advance. As an example, in the present embodiment, from the viewpoint of securing a minimum necessary level of a real-time property of the information included in the working machine data D1 while reducing the communication by the working machine 20, it is assumed that the working machine 20 transmits the working machine data D1 to the data matching device 10 at one-minute intervals (that is, intermittently).

### [Example of Working Machine Data]

Here, an example of the working machine data D1 will be described. As shown in FIG. 3, the working machine data D1 is such that a plurality of pieces of information are associated indicating a battery ID of the battery BAT attached to the working machine 20 when the working machine data D1 is generated, a time when the working machine data D1 is generated, and a position and an operating state of the working machine 20 at the time. The operating state of the working machine 20 is, for example, whether a main power supply switch of the working machine 20 is on or off.

For example, the working machine data D1 shown in FIG. 3 indicates that at a time “Aug. 1, 2021, 10:00 am”, the working machine 20 to which the battery BAT with a battery ID “BAT” is attached is located at a point P0 and an operating state thereof is on.

By appropriately communicating with the battery IC of the battery BAT attached to the working machine 20, for example, the control unit 21 of the working machine 20 can obtain information indicating the battery ID of the battery BAT. The communication between the battery BAT and the working machine 20 may be performed via a physical terminal or the like, or may be performed by short-range wireless communication.

### [Charging Device]

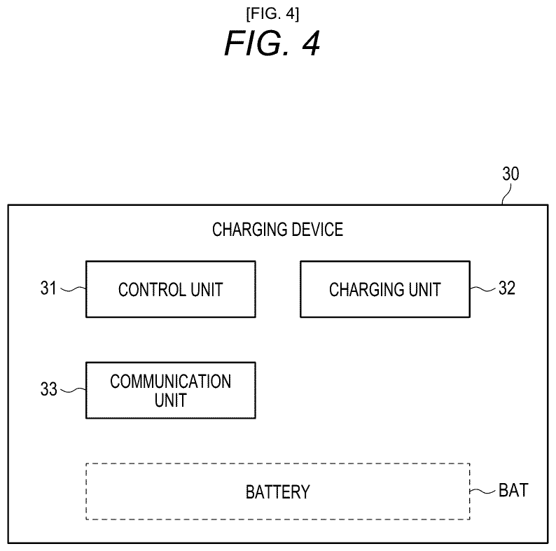

Next, the charging device 30 will be specifically described. As shown in FIG. 4, the charging device 30 includes a control unit 31, a charging unit 32, and a communication unit 33. As described above, the battery BAT can be attached to the charging device 30, and the battery BAT attached to the charging device 30 is indicated by a broken line in FIG. 4.

The control unit 31 integrally controls the entire charging device 30. The control unit 31 is implemented by, for example, a microcontroller including a processor, a memory, an input and output interface, and the like. The charging unit 32 supplies electric power from the external power supply to the battery BAT attached to the charging device 30 under the control of the control unit 31. The charging unit 32 is implemented by, for example, an electric circuit by combining various electronic components.

The communication unit 33 communicates with the outside of the charging device 30 (for example, the data matching device 10) under the control of the control unit 3. The communication unit 33 is implemented by, for example, a communication interface that can access the network NET via a fixed line such as an optical line. The communication unit 33 may be connected to the fixed line via a wireless or wired local area network (LAN), for example.

As described above, when the battery BAT is attached to the charging device 30, the battery BAT transmits the battery data (hereinafter, also referred to as “battery data D2”) in which the battery ID and the log data Lg are associated with each other to the charging device 30. When receiving the battery data D2 transmitted from the battery BAT, the control unit 31 of the charging device 30 transmits the battery data D2 to the data matching device 10 by the communication unit 33 (see also FIG. 1).

### [Example of Battery Data]

Here, an example of the battery data D2 will be described. As shown in FIG. 5, the battery data D2 is such that a battery ID is associated with log data Lg stored in a battery BAT identified by the battery ID.

As described above, the log data Lg is the information indicating the time-series change or the like of the output voltage of the battery BAT in the target period. However, the battery BAT of the present embodiment does not have a real time clock (RTC) from the viewpoint of cost reduction. Therefore, as shown in FIG. 5, an elapsed time after the battery BAT is removed from the charging device 30 is used as an element indicating a time series in the log data Lg.

For example, the battery data D2 shown in FIG. 5 indicates that an output voltage of the battery BAT with the battery ID “BAT1” when the battery BAT is removed from the charging device 30 (that is, the elapsed time is 0 [s]) is V0, the output voltage of the battery BAT one hour after the battery BAT is removed from the charging device 30 (that is, the elapsed time is 3600 [s]) is V1, and the output voltage of the battery BAT one hour and one minute after the battery BAT is removed from the charging device 30 (that is, the elapsed time is 3660 [s]) is V2.

When the battery BAT is attached to or detached from the charging device 30, the control unit 31 of the charging device 30 transmits battery attachment and detachment information indicating that the attachment and detachment of the battery BAT is performed to the data matching device 10 by the communication unit 33. Here, the battery attachment and detachment information includes information indicating the battery ID of the battery BAT attached to or detached from the charging device 30, a time at which the attachment and detachment is performed, and that the battery is attached to the charging device 30 or removed from the charging device 30 (for example, see FIG. 8).

### [Data Matching Device]

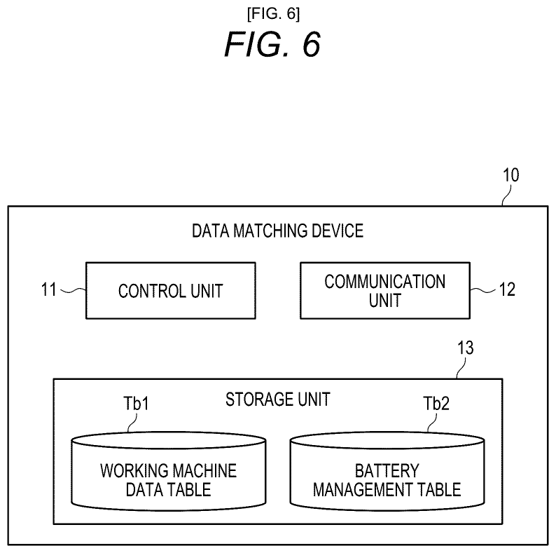

Next, the data matching device 10 will be specifically described. As shown in FIG. 6, the data matching device 10 includes a control unit 11, a communication unit 12, and a storage unit 13. The control unit 11 integrally controls the entire data matching device 10. The control unit 11 is implemented by, for example, a processor of a computer that implements the data matching device 10 executing a program stored in a memory or the like.

The communication unit 12 communicates with the outside of the data matching device 10 (for example, the working machine 20, the charging device 30, and the computer 40) under the control of the control unit 11. The communication unit 12 is implemented by, for example, a communication interface that can access the network NET. The storage unit 13 is implemented by a storage medium such as a memory or a hard disk, and stores various information including a working machine data table Tb1 and a battery management table Tb2.

The control unit 11 is configured to obtain the working machine data D1 transmitted from the working machine 20. Specifically, the control unit 11 obtains the working machine data D1 transmitted from the working machine 20 by receiving the working machine data D1 by the communication unit 12. When the working machine data D1 is obtained, the control unit 11 stores the obtained working machine data D1 in the working machine data table Tb1.

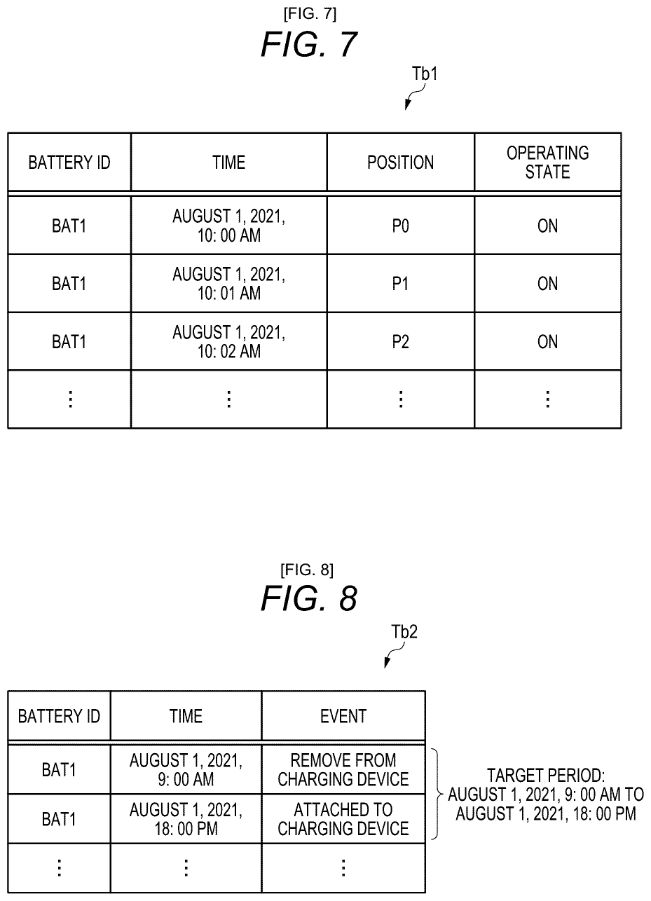

FIG. 7 shows an example of the working machine data table Tb1. The working machine data table Tb1 shown in FIG. 7 stores the working machine data D1 transmitted to the data matching device 10 from the working machine 20 to which the battery BAT with the battery ID “BAT1” is attached at each of times of “Aug. 1, 2021, 10:00 am”, “Aug. 1, 2021, 10:01 am”, and “Aug. 1, 2021, 10:02 am”.

When the working machine data D1 is obtained, the control unit 11 outputs the obtained working machine data D1 to the computer 40. For example, the control unit 11 transmits the obtained working machine data D1 to the computer 40 by the communication unit 12 at a timing when the working machine data D1 is obtained.

Further, the control unit 11 is configured to obtain the battery attachment and detachment information transmitted from the charging device 30. Specifically, the control unit 11 obtains the battery attachment and detachment information transmitted from the charging device 30 by receiving the battery attachment and detachment information by the communication unit 12. When the battery attachment and detachment information is obtained, the control unit 11 stores the obtained battery attachment and detachment information in the battery management table Tb2.

FIG. 8 shows an example of the battery management table Tb2. The battery management table Tb2 shown in FIG. 8 stores battery attachment and detachment information indicating that the battery BAT with the battery ID “BAT1” is removed from the charging device 30 at a time “Aug. 1, 2021, 9:00 am” and battery attachment and detachment information indicating that the battery is attached (in other words, returned) to the charging device 30 at a time “Aug. 1, 2021, 18:00 pm”.

Therefore, with reference to the battery management table Tb2 shown in FIG. 8, the control unit 11 can identify (recognize) that the battery BAT with the battery ID “BAT1” is removed from the charging device 30 during a period from “Aug. 1, 2021, 9:00 am” to “Aug. 1, 2021, 18:00 pm”. In this way, the control unit 11 can identify the target period in which the log data Lg is stored with reference to the battery management table Tb2.

The control unit 11 is configured to obtain the battery data D2 transmitted from the charging device 30. Specifically, the control unit 11 obtains the battery data D2 transmitted from the charging device 30 by receiving the battery data D2 by the communication unit 12.

When the battery data D2 is obtained, the control unit 11 generates matched data Dm in which the obtained working machine data D1 and battery data D2 are associated with each other. Specifically, when the battery data D2 is obtained, the control unit 11 first searches the working machine data table Tb1 for the working machine data D1 having the same battery ID as the battery ID (hereinafter, also referred to as a “target ID”) of the obtained battery data D2. Hereinafter, among the working machine data D1 stored in the working machine data table Tb1, the working machine data D1 having the same battery ID as the target ID is also referred to as “association candidate working machine data”.

For example, it is assumed that the target ID is “BAT1”. In this case, the control unit 11 searches the working machine data table Tb1 for the working machine data D1 with the battery ID “BAT1” as the association candidate working machine data. Accordingly, for example, when the working machine data table Tb1 is as shown in FIG. 7, the working machine data D1 or the like transmitted to the data matching device 10 from the working machine 20 to which the battery BAT with the battery ID “BAT1” is attached at each of the times of “Aug. 1, 2021, 10:00 am”, “Aug. 1, 2021, 10:01 am”, and “Aug. 1, 2021, 10:02 am” is found as the association candidate working machine data.

Next, the control unit 11 identifies a period in which the battery BAT with the target ID is removed from the charging device 30 (that is, the target period in which the battery BAT with the target ID stores the log data Lg) with reference to the battery management table Tb2.

For example, it is assumed that the target ID is “BAT1” and the battery management table Tb2 is as shown in FIG. 8. In this case, the control unit 11 identifies the period from “Aug. 1, 2021, 9:00 am” to “Aug. 1, 2021, 18:00 pm” as the period in which the battery BAT with the battery ID “BAT1” is removed from the charging device 30.

The control unit 11 generates the matched data Din by associating the working machine data D1 having information on a time included in the period identified as described above among the association candidate working machine data with the obtained battery data D2.

For example, it is assumed that the target ID is “BAT1” and the period in which the battery BAT with the battery ID “BAT1” is removed from the charging device 30 is identified as the period from “Aug. 1, 2021, 9:00 am” to “Aug. 1, 2021, 18:00 pm”. Here, each of the times of “Aug. 1, 2021, 10:00 am”, “Aug. 1, 2021, 10:01 am”, and “Aug. 1, 2021, 10:02 am” is a time included in the identified period. Therefore, in this case, for example, when the working machine data table Tb1 is as shown in FIG. 7, the working machine data D1 or the like transmitted to the data matching device 10 from the working machine 20 to which the battery BAT with the battery ID “BAT1” is attached at each of the times of “Aug. 1, 2021, 10:00 am”, “Aug. 1, 2021, 10:01 am”, and “Aug. 1, 2021, 10:02 am” is associated with the battery data D2 to generate the matched data Dm.

In addition, with reference to the time when the battery BAT is removed from the charging device 30 and the elapsed time in the log data Lg of the battery BAT, the control unit 11 can identify which time each output voltage or the like indicated by the log data Lg corresponds to. Therefore, when generating the matched data Dm, the control unit 11 can also associate the output voltage or the like at a certain time indicated by the log data Lg with the working machine data. D1 at the time. Specifically, for example, the control unit 11 may associate the working machine data D1 having the time of “Aug. 1, 2021, 10:00 am” with a location corresponding to “Aug. 1, 2021, 10:00 am” indicated by the log data Lg. Accordingly, it is possible to generate the matched data Dm in which the working machine data D1 and the battery data D2 are associated more precisely in time series.

When the matched data Dm is generated in this way, the control unit 11 outputs the generated matched data Dm to the computer 40 (see also FIG. 1). Accordingly, the data matching device 10 can provide the operator with the matched data Dm in which the working machine data D1 related to the working machine 20 and the battery data D2 related to the battery BAT used in the working machine 20 are associated with each other. Therefore, even when a communication amount of the working machine 20 is reduced, the operator can obtain the matched data Dm necessary for grasping working efficiency of the working machine 20, or the like.

### [Data Matching Process Executed by Data Matching Device]

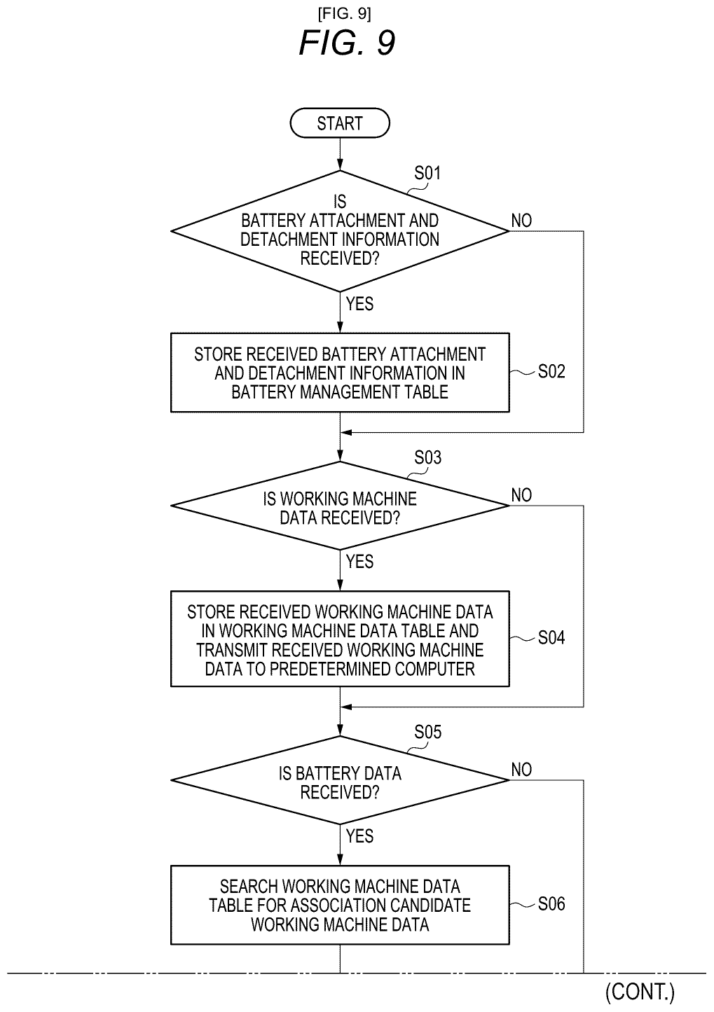

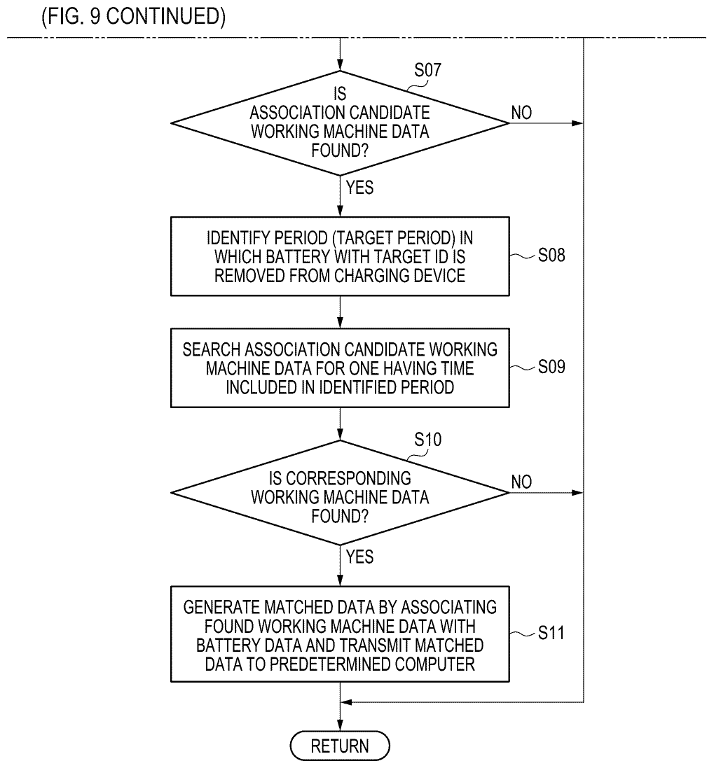

Next, an example of a data matching process (data matching method) executed by the data matching device 10 will be described with reference to FIG. 9. The data matching device 10 repeatedly executes, for example, the data matching process shown in FIG. 9 at a predetermined cycle. The data matching program that causes the data matching device 10 to execute the data matching process is stored in advance in a storage medium or the like (for example, the storage unit 13) of the data matching device 10.

The data matching device 10 determines whether the battery attachment and detachment information is received from the charging device 30 (step S01). Then, when it is determined that the battery attachment and detachment information is not received (step S01: NO), the data matching device 10 proceeds to a process of step S03 as it is. On the other hand, when it is determined that the battery attachment and detachment information is received (step S01: YES), the data matching device 10 stores the received battery attachment and detachment information in the battery management table Tb2 (step S02), and proceeds to the process of step S03.

Next, the data matching device 10 determines whether the working machine data D1 is received from the working machine 20 (step S03). Then, when it is determined that the working machine data D1 is not received (step S03: NO), the data matching device 10 proceeds to a process of step S05 as it is. On the other hand, when it is determined that the working machine data D1 is received (step S03: YES), the data matching device 10 stores the received working machine data D1 in the working machine data table Tb1 and transmits the working machine data D1 to the computer 40 (step S04), and proceeds to the process of step S05.

Next, the data matching device 10 determines whether the battery data D2 is received from the charging device 30 (step S05). Then, when it is determined that the battery data D2 is not received (step S05: NO), the data matching device 10 ends the series of processes shown in FIG. 9.

On the other hand, when it is determined that the battery data D2 is received (step S05: YES), the data matching device 10 searches the working machine data table Tb1 for the association candidate working machine data (step S06). As described above, here, the association candidate working machine data is the working machine data D1 having the same battery ID as the battery ID (that is, the target ID) of the obtained (received) battery data D2 among the working machine data D1 stored in the working machine data table Tb1.

Next, the data matching device 10 determines whether the association candidate working machine data is found (step S07). Then, when it is determined that the association candidate working machine data is not searched (step S07: NO), the data matching device 10 ends the series of processes shown in FIG. 9. On the other hand, when it is determined that the association candidate working machine data is searched (step S07: YES), the data matching device 10 identifies a period in which the battery BAT with the target ID is removed from the charging device 30 (that is, the target period in which the battery BAT with the target ID stores the log data Lg) with reference to the battery management table Tb2 (step S08).

Next, the data matching device 10 searches the association candidate working machine data for one having information on a time included in the period identified by a process of step S08 (step S09). Then, the data matching device 10 determines whether the corresponding working machine data D1 is found by a process of step S09 (step S10).

When it is determined that the corresponding working machine data D1 is not found (step S10: NO), the data matching device 10 ends the series of processes shown in FIG. 9. On the other hand, when it is determined that the corresponding working machine data D1 is found (step S10: YES), the data matching device 10 generates the matched data Din by associating all the working machine data D1 found in the process of step S09 with the received battery data D2 and transmits the matched data Dm to the computer 40 (step S11), and ends the series of processes shown in FIG. 9.

In the above example, the data matching device 10 generates the matched data Dm and transmits the matched data Dm to the computer 40 at a timing of receiving the battery data D2, but the present invention is not limited thereto. For example, after receiving the battery data D2, in response to a request to output the matched data Dm from the computer 40, the data matching device 10 may generate the matched data Dm and transmit the matched data Dm to the computer 40. In this way, the matched data Din can be provided at a timing desired by the user such as the operator.

In the above example, when the association candidate working machine data is not found, the data matching device 10 ends the series of processes shown in FIG. 9 as it is, but the present invention is not limited thereto. For example, when the association candidate working machine data is not found, the data matching device 10 may transmit, to the computer 40, error information indicating that the battery BAT may not be one that is attached to or detached from a target charging device 30 (charging device 30 for charging the battery BAT used in the working machine 20). Based on the error information, for example, it is possible to prevent a mixture of a target battery BAT to be charged by the target charging device 30 and a non-target battery (for use other than the working machine 20). Similarly, when it is determined that the corresponding working machine data D1 is not found, the data matching device 10 may transmit predetermined error information to the computer 40.

As described above, the data matching device 10 can obtain the working machine data D1 that is transmitted from the working machine 20 for performing wireless communication and that is related to the working machine 20, and the battery data D2 that is transmitted from the charging device 30 for charging the battery BAT used in the working machine 20 and that is related to the battery BAT. When the working machine data D1 and the battery data D2 are obtained, the data matching device 10 generates the matched data Dm in which the obtained working machine data D1 and battery data D2 are associated with each other, and outputs the generated matched data Dm to the computer 40. Accordingly, the communication amount of the working machine 20 can be reduced as compared with a case where the working machine 20 transmits the working machine data D1 and the battery data D2 to the computer 40. Even when the communication amount of the working machine 20 is reduced in this way, the matched data Din in which the working machine data D1 and the battery data D2 are associated with each other can be provided to the user such as the operator, and thus it is possible to prevent a decrease in convenience of the user.

The battery BAT is configured to store the log data Lg regarding the use state of the battery BAT and output the stored log data Lg to the charging device 30. The battery data D2 transmitted from the charging device 30 to the data matching device 10 includes the log data Lg output from the battery BAT to the charging device 30. Accordingly, the data matching device 10 can generate the matched data Dm including the log data Lg regarding the use state of the battery BA used in the working machine 20.

The working machine data D1 includes the information indicating the position and the operating state of the working machine 20 at a predetermined time. Accordingly, the data matching device 10 can generate the matched data Dm including the information indicating the position and the operating state of the working machine 20 at the predetermined time.

In the present embodiment, the working machine data D1 includes the information indicating the position and the operating state of the working machine 20, but the present invention is not limited thereto. The working machine data D1 may include only one of the position and the operating state of the working machine 20. When the working machine data D1 includes only one of the position and the operating state of the working machine 20, the communication amount of the working machine 20 can be further reduced. For example, when it is determined in advance that the working machine 20 works only at a specific work site, information indicating a position of the working machine 20 (that is, a location of the work site) can be stored in the data matching device 10 or the computer 40 in advance. In such a case, even if the working machine data D1 does not include the information indicating the position of the working machine 20, by using the information indicating the position of the working machine 20 stored in advance in the data matching device 10 or the like, for example, the above matched data Dm can be generated.

The working machine data D1 and the battery data D2 include the battery ID that is identification information for identifying the battery BAT, and the data matching device 10 generates the matched data Dm in which the working machine data D1 and the battery data D2 that have the same battery ID are associated with each other. Accordingly, even when there are a plurality of batteries BAT, the data matching device 10 can generate the matched data Dm in which the working machine data D1 related to the working machine 20 and the battery data D2 related to the battery BAT used in the working machine 20 are appropriately associated with each other.

In the present embodiment, the matched data Dm in which the working machine data D1 and the battery data D2 that have the same battery ID are associated with each other is generated, but the present invention is not limited thereto. Instead of the battery FD in the present embodiment, a working machine ID for identifying the working machine 20 may be used. For example, in this case, the working machine 20 transmits the working machine data D1 including a working machine ID of an own machine to the data matching device 10. The working machine 20 notifies the attached battery BAT (battery IC) with the working machine ID of the own machine. The battery BAT transmits the battery data D2 in which the working machine ID and the log data Lg are associated with each other to the charging device 30, and the charging device 30 transmits the battery data D2 to the data matching device 10. Accordingly, the data matching device 10 can generate the matched data Dm in which the working machine data D1 and the battery data D2 that have the same working machine ID are associated with each other.

Both the battery ID and the working machine ID may be included in each of the working machine data D1 and the battery data D2, and the data matching device 10 may generate the matched data Dm in which the working machine data D1 and the battery data D2 that have the same battery ID and the same working machine ID are associated with each other.

The battery data D2 includes the log data Lg regarding the use state of the battery BAT in the target period from when the battery BAT is removed from the charging device 30 to when the battery BAT is attached to the charging device 30 again. The data matching device 10 generates the matched data Dm in which the working machine data D1 corresponding to the time included in the target period in which the log data Lg of the obtained battery data D2 is stored is associated with the obtained battery data D2. Accordingly, the data matching device 10 can generate the matched data Dm in which the working machine data D1 and the battery data D2 that are appropriate in time series are associated with each other.

When the battery BAT is attached to or detached from the charging device 30, the charging device 30 transmits the battery attachment and detachment information indicating that the attachment and detachment of the battery BAT is performed to the data matching device 10. The data matching device 10 identifies the target period in which the log data Lg is stored, based on the battery attachment and detachment information transmitted from the charging device 30. Accordingly, even if the log data Lg does not include the information on the time at which the log data Lg is stored, the data matching device 10 can generate the matched data Dm in which the working machine data D1 and the battery data D2 that are appropriate in time series are associated with each other. Therefore, the RTC or the like can be omitted from the battery BAT, and a configuration of the battery BAT can be simplified.

When only the working machine data D1 in the working machine data D1 and the battery data D2 is obtained, the data matching device 10 outputs the obtained working machine data D1 to the computer 40. Accordingly, the data matching device 10 can quickly output, to the computer 40, the working machine data D1 including information in which a real-time property is emphasized, and it is possible to avoid a decrease in convenience of the user such as the operator due to a delay in transmission of the information.

At the timing when the working machine data D1 is obtained, the data matching device 10 outputs the working machine data D1 to the computer 40. Accordingly, the data matching device 10 can quickly output, to the computer 40, the working machine data D1 including the information in which the real-time property is emphasized, and it is possible to avoid the decrease in the convenience of the user such as the operator due to the delay in the transmission of the information. When the battery data D2 is obtained after outputting the working machine data D1 to the computer 40, the data matching device 10 outputs the matched data Dim in which the working machine data D1 and the battery data D2 are associated with each other to the computer 40. Accordingly, when the battery data D2 is obtained after the working machine data D1 is output, the matched data Dm can be provided to the user such as the operator.

The present invention is not limited to the above embodiment, and modifications, improvements, and the like can be appropriately made. For example, in the above embodiment, an example has been described in which the working machine which is the example of the moving object in the present invention is the lawn mower or the like, but the working machine may be an industrial machine or the like driven by electric power of a battery BAT. The moving object in the present invention is not limited to such a working machine. That is, the moving object may be any object as long as the object can perform wireless communication and is driven by electric power of a predetermined battery such as the battery BAT in the above embodiment, and may be, for example, a vehicle (including both a four-wheel vehicle and a two-wheeled vehicle), a robot, a ship, or an aircraft.

In the present description, at least the following matters are described. Although corresponding constituent elements or the like in the above embodiment are shown in parentheses, the present invention is not limited thereto.

(1) A data matching device (data matching device 10) capable of obtaining first data (working machine data D1) that is transmitted from a moving object (working machine 20) configured to perform wireless communication and that is related to the moving object, and second data (battery data D2) that is transmitted from a charging device (charging device 30) configured to charge a battery (battery BAT) used in the moving object and that is related to the battery, in which the data matching device is configured to:
generate matched data (matched data Dm) in which the obtained first data and the obtained second data are associated with each other, when obtaining the first data and the second data; and
output the generated matched data to a predetermined output destination.

According to (1), it is possible to reduce a communication amount of the moving object as compared with a case where the moving object transmits the first data and the second data. Even when the communication amount of the moving object is reduced in this way, the matched data in which the first data and the second data are associated with each other can be output to the predetermined output destination, and thus it is possible to prevent a decrease in convenience of a user.

(2) The data matching device according to (1), in which
the battery is configured to store log data (log data Lg) regarding a use state of the battery and output the stored log data to the charging device, and
the second data includes the log data output from the battery to the charging device.

According to (2), it is possible to generate the matched data including the log data relating to the use state of the battery used in the moving object.

(3) The data matching device according to (1 or (2), in which
the first data includes information indicating a position and/or an operating state of the moving object at a predetermined time.

According to (3), it is possible to generate the matched data including the information indicating the position and the operating state of the moving object at the predetermined time.

(4) The data matching device according to any one of (1) to (3), in which
the first data and the second data include identification information for identifying the battery and/or the moving object, and
the data matching device generates the matched data in which the first data and the second data that include the same identification information are associated with each other.

According to (4), even when there are a plurality of batteries, it is possible to generate the matched data in which the first data related to the moving object and the second data related to the battery used in the moving object are appropriately associated with each other.

(5) the Data Matching Device According to any One of (1) to (4), in which
the battery is configured to store log data regarding a use state of the battery in a target period from when the battery is removed from the charging device to when the battery is attached to the charging device again, and output the stored log data to the charging device,
the second data includes the log data output from the battery to the charging device,
the first data includes information indicating a position and/or an operating state of the moving object at a predetermined time, and
the data matching device generates the matched data in which the first data corresponding to a time included in the target period in which the log data of the obtained second data is stored is associated with the second data.

According to (5), it is possible to generate the matched data in which the first data and the second data that are appropriate in time series are associated with each other.

(6) The data matching device according to (5), in which
the charging device further transmits battery attachment and detachment information indicating that attachment or detachment of the battery is performed to the data matching device, in response to the battery being attached to or detached from the charging device, and
the data matching device identifies the target period based on the battery attachment and detachment information.

According to (6), even if the log data does not include information on a time at which the log data is stored, it is possible to generate the matched data in which the first data and the second data that are appropriate in time series are associated with each other.

(7) The data matching device according to any one of (1) to (6), in which
the data matching device outputs the obtained first data to the predetermined output destination, when obtaining only the first data of the first data and the second data.

The first data related to the working machine may include information in which a real-time property is emphasized. According to (7), it is possible to quickly output the first data that may include the information in which the real-time property is emphasized, and it is possible to avoid a decrease in convenience of the user due to a delay in transmission of the information.

(8) The data matching device according to any one of (1) to (7), in which
the data matching device outputs the obtained first data to the predetermined output destination at a timing when the first data is obtained, and
the data matching device outputs the matched data in which the first data and the second data are associated with each other to the predetermined output destination, when obtaining the second data after outputting the first data to the predetermined output destination.

According to (8), the first data is output to the predetermined output destination at the timing when the first data is obtained. Accordingly, it is possible to quickly output the first data that may include the information in which the real-time property is emphasized, and it is possible to avoid the decrease in the convenience of the user due to the delay in the transmission of the information. When the second data is obtained after the first data is output, the matched data in which the first data and the second data are associated with each other is output to the predetermined output destination. Accordingly, when the second data is obtained after the first data is output, the matched data can be provided to the user.

(9) A data matching method performed by a computer capable of obtaining first data that is transmitted from a moving object configured to perform wireless communication and that is related to the moving object, and second data that is transmitted from a charging device configured to charge a battery used in the moving object and that is related to the battery, the data matching method including:
generating matched data in which the obtained first data and the obtained second data are associated with each other, when obtaining the first data and the second data; and
outputting the generated matched data to a predetermined output destination.

According to (9), it is possible to reduce a communication amount of the moving object as compared with a case where the moving object transmits the first data and the second data. Even when the communication amount of the moving object is reduced in this way, the matched data in which the first data and the second data are associated with each other can be output to the predetermined output destination, and thus it is possible to prevent a decrease in convenience of a user.

(10) A data matching program causing a computer to execute a process, the computer being capable of obtaining first data that is transmitted from a moving object configured to perform wireless communication and that is related to the moving object, and second data that is transmitted from a charging device configured to charge a battery used in the moving object and that is related to the battery, the process including:
generating matched data in which the obtained first data and the obtained second data are associated with each other, when obtaining the first data and the second data; and
outputting the generated matched data to a predetermined output destination.

According to (10), it is possible to reduce a communication amount of the moving object as compared with a case where the moving object transmits the first data and the second data. Even when the communication amount of the moving object is reduced in this way, the matched data in which the first data and the second data are associated with each other can be output to the predetermined output destination, and thus it is possible to prevent a decrease in convenience of a user.

### REFERENCE SIGNS LIST

1: data matching system
10: data matching device
20: working machine (moving object)
30: charging device
BAT: battery
D1: working machine data (first data)
D2: battery data (second data)
Dm: matched data
Lg: log data

1. A data matching device capable of obtaining first data that is transmitted from a moving object configured to perform wireless communication and that is related to the moving object, and second data that is transmitted from a charging device configured to charge a battery used in the moving object and that is related to the battery, wherein the data matching device is configured to:
generate matched data in which the obtained first data and the obtained second data are associated with each other, when obtaining the first data and the second data; and
output the generated matched data to a predetermined output destination.

2. The data matching device according to claim 1, wherein
the battery is configured to store log data regarding a use state of the battery and output the stored log data to the charging device, and
the second data includes the log data output from the battery to the charging device.

3. The data matching device according to claim 1, wherein
the first data includes information indicating a position and/or an operating state of the moving object at a predetermined time.

4. The data matching device according to claim 1, wherein
the first data and the second data include identification information for identifying the battery and/or the moving object, and
the data matching device generates the matched data in which the first data and the second data that include the same identification information are associated with each other.

5. The data matching device according to claim 1, wherein
the battery is configured to store log data regarding a use state of the battery in a target period from when the battery is removed from the charging device to when the battery is attached to the charging device again, and output the stored log data to the charging device,
the second data includes the log data output from the battery to the charging device,
the first data includes information indicating a position and/or an operating state of the moving object at a predetermined time, and
the data matching device generates the matched data in which the first data corresponding to a time included in the target period in which the log data of the obtained second data is stored is associated with the second data.

6. The data matching device according to claim 5, wherein
the charging device further transmits battery attachment and detachment information indicating that attachment or detachment of the battery is performed to the data matching device, in response to the battery being attached to or detached from the charging device, and
the data matching device identifies the target period based on the battery attachment and detachment information.

7. The data matching device according to claim 1, wherein
the data matching device outputs the obtained first data to the predetermined output destination, when obtaining only the first data of the first data and the second data.

8. The data matching device according to claim 1, wherein
the data matching device outputs the obtained first data to the predetermined output destination at a timing when the first data is obtained, and
the data matching device outputs the matched data in which the first data and the second data are associated with each other to the predetermined output destination, when obtaining the second data after outputting the first data to the predetermined output destination.

9. A data matching method performed by a computer capable of obtaining first data that is transmitted from a moving object configured to perform wireless communication and that is related to the moving object, and second data that is transmitted from a charging device configured to charge a battery used in the moving object and that is related to the battery, the data matching method comprising:
generating matched data in which the obtained first data and the obtained second data are associated with each other, when obtaining the first data and the second data; and
outputting the generated matched data to a predetermined output destination.

10. A non-transitory computer-readable storage medium storing a data matching program that causes a computer to execute a process, the computer being capable of obtaining first data that is transmitted from a moving object configured to perform wireless communication and that is related to the moving object, and second data that is transmitted from a charging device configured to charge a battery used in the moving object and that is related to the battery, the process comprising:
generating matched data in which the obtained first data and the obtained second data are associated with each other, when obtaining the first data and the second data; and
outputting the generated matched data to a predetermined output destination.
